(19) United States
(12) Patent Application Publication
(10) Pub. No.: US 2026/0088362 A1
(43) Pub. Date: Mar. 26, 2026

(54) ELECTROLYTIC SOLUTION FOR SECONDARY BATTERY, AND SECONDARY BATTERY

(71) Applicant: MURATA MANUFACTURING CO., LTD., Kyoto (JP)

(72) Inventors: Kikou YAMAGUCHI, Kyoto (JP); Yasuyuki MASUDA, Kyoto (JP)

(21) Appl. No.: 19/408,812

(22) Filed: Dec. 4, 2025

Related U.S. Application Data
(63) Continuation of application No. PCT/JP2024/023116, filed on Jun. 26, 2024.

(30) Foreign Application Priority Data
Jul. 11, 2023 (JP) 2023-113810

(51) Int. Cl. H01M 10/0569; H01M 10/0525

(52) U.S. Cl. CPC H01M 10/0569; H01M 10/0525; H01M 2300/0034; H01M 2300/0037

(57) ABSTRACT

A secondary battery is provided and includes a positive electrode, a negative electrode, and an electrolytic solution. The electrolytic solution includes a solvent. The solvent includes an anisole compound represented by Formula (1), and a content of the anisole compound in the solvent is 30 wt % or greater.

### CROSS REFERENCE TO RELATED APPLICATIONS

The present application is a continuation of International Application No. PCT/JP2024/023116, filed on Jun. 26, 2024, which claims priority to Japanese Patent Application No. 2023-113810, filed on Jul. 11, 2023, the entire contents of which are incorporated herein by reference.

### BACKGROUND

The present technology relates to an electrolytic solution for a secondary battery, and to a secondary battery.

Various kinds of electronic equipment, including mobile phones, have been widely used. Such widespread use has promoted development of a secondary battery as a power source that is smaller in size and lighter in weight and allows for a higher energy density.

The secondary battery includes a positive electrode, a negative electrode, and an electrolytic solution. A configuration of the secondary battery has been considered in various ways.

For example, a non-aqueous electrolytic solution includes a fluorine-containing organic compound, and a content of the fluorine-containing organic compound in the non-aqueous electrolytic solution is within a range from 0.01 wt % to 20 wt % both inclusive. An electrolytic solution includes dimethoxyethane and anisole, and a mixture ratio (a mole ratio) between dimethoxyethane and anisole is 1:2.

### SUMMARY

The present technology relates to an electrolytic solution for a secondary battery, and to a secondary battery.

Although consideration has been given in various ways regarding a configuration of a secondary battery, a battery characteristic and safety of the secondary battery are not sufficient yet. Accordingly, there is room for improvement in terms of the battery characteristic and the safety of the secondary battery.

It is desirable to provide an electrolytic solution for a secondary battery, and a secondary battery each of which makes it possible to achieve a superior battery characteristic and superior safety.

An electrolytic solution for a secondary battery according to an embodiment of the present technology includes a solvent. The solvent includes an anisole compound represented by Formula (1). A content of the anisole compound in the solvent is 30 wt % or greater.

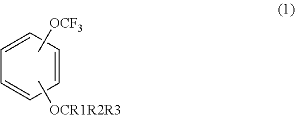

where each of R1, R2, and R3 is either a hydrogen group or a halogen group.

A secondary battery according to an embodiment of the present technology includes a positive electrode, a negative electrode, and an electrolytic solution. The electrolytic solution has a configuration similar to the above-described configuration of the electrolytic solution for the secondary battery according to an embodiment of the present technology.

As indicated in Formula (1), the anisole compound is a compound in which a trifluoromethoxy group (—OCF₃) and a methoxy-type group (—OCR1R2R3) are bonded to a benzene ring. Note that a position at which each of the trifluoromethoxy group and the methoxy-type group is bonded to the benzene ring is not particularly limited. Details of a configuration of the anisole compound will be described later.

According to the electrolytic solution for the secondary battery of an embodiment of the present technology, or the secondary battery of an embodiment of the present technology, the solvent includes the anisole compound represented by Formula (1), and the content of the anisole compound in the solvent is 30 wt % or greater. This makes it possible to achieve a superior battery characteristic and superior safety.

Note that effects of the present technology are not necessarily limited to those described above and may include any of a series of effects described below in relation to the present technology.

### BRIEF DESCRIPTION OF THE FIGURES

FIG. 1 is a perspective diagram illustrating a configuration of a secondary battery according to an embodiment of the present technology.

FIG. 2 is a sectional diagram illustrating, in an enlarged manner, a configuration of a battery device illustrated in FIG. 1.

FIG. 3 is a block diagram illustrating a configuration of an application example of the secondary battery.

### DETAILED DESCRIPTION

The present technology is described below in further detail including with reference to the drawings according to an embodiment.

A description is given first of an electrolytic solution for a secondary battery (hereinafter simply referred to as an “electrolytic solution”) according to an embodiment of the present technology.

The electrolytic solution is a liquid electrolyte to be used in a secondary battery, which is an electrochemical device. However, the electrolytic solution may be used in other electrochemical devices. Other electrochemical devices are not particularly limited in kind, and specific examples thereof include a capacitor.

The electrolytic solution includes a solvent. More specifically, the electrolytic solution further includes an electrolyte salt that is to be ionized in the solvent.

The solvent is a medium that allows the electrolyte salt to be dissolved and ionized. The solvent to be used here is a non-aqueous solvent. Therefore, the electrolytic solution including the non-aqueous solvent is what is called a non-aqueous electrolytic solution.

The solvent includes any one or more of anisole compounds each represented by Formula (1).

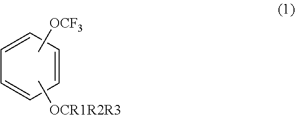

where each of R1, R2, and R3 is either a hydrogen group or a halogen group.

The anisole compound is a compound in which a trifluoromethoxy group (—OCF₃) and a methoxy-type group (—OCR1R2R3) are bonded to a benzene ring, as described above. Note that a position at which each of the trifluoromethoxy group and the methoxy-type group is bonded to the benzene ring is not particularly limited.

Therefore, when a position at which the trifluoromethoxy group is bonded to the benzene ring is regarded as a reference, the methoxy-type group may be at an ortho position with respect to the trifluoromethoxy group, may be at a meta position with respect to the trifluoromethoxy group, or may be at a para position with respect to the trifluoromethoxy group.

Each of R1 to R3 is either a hydrogen group or a halogen group, as described above. R1 to R3 may be the same as each other in kind, or may be different from each other in kind. It goes without saying that only any two of R1 to R3 may be the same as each other in kind.

The halogen group is not particularly limited in kind, and specific examples thereof include a fluorine group, a chlorine group, a bromine group, and an iodine group.

Specific examples of the anisole compound include 2-(trifluoromethoxy)anisole (R1=R2=R3=a hydrogen group), 3-(trifluoromethoxy)anisole (R1=R2=R3=a hydrogen group), 4-(trifluoromethoxy)anisole (R1=R2=R3=a hydrogen group), and 4-(trifluoromethoxy)trifluoroanisole (R1=R2=R3=a fluorine group).

Note that a content of the anisole compound in the solvent is set to be a predetermined amount. Specifically, the content of the anisole compound in the solvent is 30 wt % or greater.

One reason why the solvent includes the anisole compound and the content of the anisole compound in the solvent is 30 wt % or greater is that this suppresses a decomposition reaction of the electrolytic solution upon charging and discharging of the secondary battery including the electrolytic solution while securing safety during use of the secondary battery.

More specifically, the anisole compound has a low coordinating property with respect to an alkali metal ion, as compared with another compound to be described later. The alkali metal ion is derived from a cation included in the electrolyte salt. More specifically, the alkali metal ion is, for example, a lithium ion to be described later. For a reason described above, in the electrolytic solution, the other compound easily coordinates to the alkali metal ion, whereas the anisole compound does not easily coordinate to the alkali metal ion.

It is known that the other compound coordinating to the alkali metal ion is easily reduced and decomposed, as compared with the other compound not coordinating to the alkali metal ion. An anion included in the electrolyte salt also has a tendency similar to the above-described tendency regarding reductive decomposition of the other compound. In contrast, because the anisole compound does not easily coordinate to the alkali metal ion as described above, the anisole compound is not easily reduced and decomposed.

Accordingly, because each of the other compound and the anion is easily reduced and decomposed while the anisole compound is not easily reduced and decomposed, it is possible to adjust an electrochemical state of a film to be formed on a surface of a negative electrode by changing a kind of each of the other compound and the anion The film will be described later.

In addition, the trifluoromethoxy group in the anisole compound includes fluorine as a constituent element. Accordingly, when the anisole compound is decomposed upon charging and discharging of the secondary battery, a favorable film including fluorine as a constituent element is easily formed on the surface of the negative electrode. Therefore, the surface of the negative electrode is electrochemically protected by using the film. For such a reason, even if the negative electrode has high reactivity, the decomposition reaction of the electrolytic solution is suppressed on the surface of the negative electrode.

Furthermore, the anisole compound has a high boiling point and a high flash temperature, as compared with the other compound. This helps to prevent the electrolytic solution from easily boiling or easily catching fire even if a temperature of the secondary battery increases for some reason during the use of the secondary battery.

Accordingly, the decomposition reaction of the electrolytic solution is suppressed upon charging and discharging of the secondary battery while safety is secured during the use of the secondary battery.

In this case, because the content of the anisole compound in the solvent is made appropriate in particular, a protection function of the anisole compound protecting the surface of the negative electrode is effectively exhibited. This allows the surface of negative electrode to be sufficiently and stably protected by using the film, and thus, sufficiently and stably suppresses the decomposition reaction of the electrolytic solution.

In particular, the content of the anisole compound in the solvent is preferably 60 wt % or greater. One reason for this is that this allows the protection function of the anisole compound to be more effectively exhibited, and thus further suppresses the decomposition reaction of the electrolytic solution.

In addition, the content of the anisole compound in the solvent is preferably 80 wt % or less. One reason for this is that this sufficiently suppresses the decomposition reaction of the electrolytic solution while securing solubility of the electrolyte salt in the electrolytic solution.

The halogen group preferably includes a fluorine group. One reason for this is that this improves reactivity of the anisole compound, and thus allows the film to be more easily formed on the surface of the negative electrode.

The anisole compound preferably includes a compound represented by Formula (2). In other words, the methoxy-type group is preferably at the para position with respect to the trifluoromethoxy group. One reason for this is that this improves the reactivity of the anisole compound, and thus allows the film to be more easily formed on the surface of the negative electrode. Note that details of R4 to R6 are similar to the details of R1 to R3.

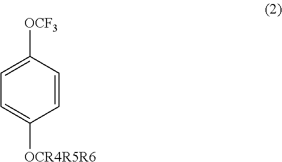

where each of R4, R5, and R6 is either a hydrogen group or a halogen group.

Specific examples of the compound represented by Formula (2) include 4-(trifluoromethoxy)anisole (R4=R5=R6=a hydrogen group) and 4-(trifluoromethoxy)trifluoroanisole (R4=R5=R6=a fluorine group), as described above.

Further, the anisole compound preferably includes 4-(trifluoromethoxy)anisole. One reason for this is that this allows the protection function of the anisole compound to be sufficiently exhibited, and thus sufficiently suppresses the decomposition reaction of the electrolytic solution.

To confirm that the solvent includes the anisole compound and to measure the content of the anisole compound in the solvent, the electrolytic solution is analyzed. A method of analyzing the electrolytic solution is not particularly limited, and specifically includes any one or more of methods including, without limitation, inductively coupled plasma (ICP) optical emission spectroscopy, nuclear magnetic resonance (NMR) spectroscopy, and gas chromatography mass spectrometry (GC-MS).

When a secondary battery including the electrolytic solution is used to analyze the electrolytic solution, the secondary battery is disassembled to take out the electrolytic solution, following which the electrolytic solution is analyzed. This allows for identification of a kind (the anisole compound) of a component included in the electrolytic solution, and also allows for identification of a content of the component.

The solvent may further include any one or more of other compounds. As is apparent from the above-described range of the content of the anisole compound in the solvent, the solvent may include another compound together with the anisole compound.

The other compound is a non-aqueous solvent (an organic solvent). Note that the anisole compound described above is excluded from the other compound described here.

The non-aqueous solvent is, for example, an ester or an ether, more specifically, a carbonic-acid-ester-based compound, a carboxylic-acid-ester-based compound, or a lactone-based compound, for example. One reason for this is that a dissociation property of the electrolyte salt improves and ion mobility also improves.

The carbonic-acid-ester-based compound is, for example, a cyclic carbonic acid ester or a chain carbonic acid ester. Specific examples of the cyclic carbonic acid ester include ethylene carbonate and propylene carbonate, and specific examples of the chain carbonic acid ester include dimethyl carbonate, diethyl carbonate, and ethyl methyl carbonate.

The carboxylic-acid-ester-based compound is, for example, a chain carboxylic acid ester. Specific examples of the chain carboxylic acid ester include ethyl acetate, ethyl propionate, propyl propionate, and ethyl trimethylacetate.

The lactone-based compound is, for example, a lactone. Specific examples of the lactone include γ-butyrolactone and γ-valerolactone.

Note that the ether may be, for example, 1,2-dimethoxyethane, tetrahydrofuran, 1,3-dioxolane, 1,4-dioxane, or anisole.

The non-aqueous solvent may be, for example, an unsaturated cyclic carbonic acid ester, a fluorinated cyclic carbonic acid ester, a sulfonic acid ester, a phosphoric acid ester, an acid anhydride, a nitrile compound, or an isocyanate compound. One reason for this is that electrochemical stability of the electrolytic solution improves.

Specific examples of the unsaturated cyclic carbonic acid ester include vinylene carbonate, vinyl ethylene carbonate, and methylene ethylene carbonate. Specific examples of the fluorinated cyclic carbonic acid ester include monofluoroethylene carbonate and difluoroethylene carbonate. Specific examples of the sulfonic acid ester include propane sultone and propene sultone. Specific examples of the phosphoric acid ester include trimethyl phosphate and triethyl phosphate. Specific examples of the acid anhydride include succinic anhydride, 1,2-ethanedisulfonic anhydride, and 2-sulfobenzoic anhydride. Specific examples of the nitrile compound include succinonitrile. Specific examples of the isocyanate compound include hexamethylene diisocyanate.

The electrolyte salt includes any one or more of light metal salts including, without limitation, a lithium salt.

Specific examples of the lithium salt include lithium hexafluorophosphate (LiPF₆), lithium tetrafluoroborate (LiBF₄), lithium trifluoromethanesulfonate (LiCF₃SO₃), lithium bis(fluorosulfonyl)imide (LiN(FSO₂)₂), lithium bis(trifluoromethanesulfonyl)imide (LiN(CF₃SO₂)₂), lithium tris(trifluoromethanesulfonyl)methide (LiC(CF₃SO₂)₃), lithium bis(oxalato)borate (LiB(C₂O₄)₂), lithium monofluorophosphate (Li₂PFO₃), and lithium difluorophosphate (LiPF₂O₂). One reason for this is that a high battery capacity is obtainable.

A content of the electrolyte salt is not particularly limited, and is specifically within a range from 0.3 mol/kg to 3.0 mol/kg both inclusive with respect to the solvent. One reason for this is that high ion conductivity is obtainable.

To manufacture the electrolytic solution, the electrolyte salt is put into the solvent including the anisole compound. In this case, an amount of the anisole compound to put in is so adjusted that the content of the anisole compound in the solvent falls within the above-described range. The electrolyte salt is thereby dissolved in the solvent. The electrolytic solution is thus prepared.

According to the electrolytic solution described above, the solvent includes the anisole compound, and the content of the anisole compound in the solvent is 30 wt % or greater.

In this case, as described above, the property of the anisole compound is used to prevent the anisole compound from easily coordinating to the alkali metal ion and to allow a favorable film including fluorine as a constituent element to be easily formed on the surface of the negative electrode upon charging and discharging of the secondary battery including the electrolytic solution. This allows the surface of the negative electrode to be electrochemically protected by using the film, and thus suppresses the decomposition reaction of the electrolytic solution on the surface of the negative electrode.

In addition, as described above, the property of the anisole compound is used to prevent the electrolytic solution from easily boiling or easily catching fire even if the temperature of the secondary battery including the electrolytic solution increases for some reason during the use of the secondary battery.

Accordingly, the decomposition reaction of the electrolytic solution is suppressed upon charging and discharging of the secondary battery including the electrolytic solution while safety is secured during the use of the secondary battery. It is thus possible to achieve a secondary battery that has a superior battery characteristic and superior safety.

In particular, the content of the anisole compound in the solvent may be 60 wt % or greater. This allows the decomposition reaction of the electrolytic solution to be further suppressed by using the protection function of the anisole compound. Accordingly, it is possible to achieve higher effects.

Further, the content of the anisole compound in the solvent may be 80 wt % or less. This allows the decomposition reaction of the electrolytic solution to be sufficiently suppressed while securing the solubility of the electrolyte salt in the electrolytic solution. Accordingly, it is possible to achieve higher effects.

Further, the halogen group may include the fluorine group. This improves the reactivity of the anisole compound, and thus allows the film to be more easily formed on the surface of the negative electrode. Accordingly, it is possible to achieve higher effects.

Further, the anisole compound may include the compound represented by Formula (2). This improves the reactivity of the anisole compound, and thus allows the film to be more easily formed on the surface of the negative electrode. Accordingly, it is possible to achieve higher effects.

Further, the anisole compound may include 4-(trifluoromethoxy)anisole. This allows the protection function of the anisole compound to be sufficiently exhibited, and thus sufficiently suppresses the decomposition reaction of the electrolytic solution. Accordingly, it is possible to achieve higher effects.

A description is given next of a secondary battery including the electrolytic solution described above.

The secondary battery to be described here is a secondary battery in which a battery capacity is obtained through insertion and extraction of an electrode reactant, and includes a positive electrode, a negative electrode, and an electrolytic solution.

Although not particularly limited in kind, the electrode reactant is specifically a light metal such as an alkali metal or an alkaline earth metal. Specific examples of the alkali metal include lithium, sodium, and potassium. Specific examples of the alkaline earth metal include beryllium, magnesium, and calcium.

The following description deals with an example case where the electrode reactant is lithium. A secondary battery in which the battery capacity is obtained through insertion and extraction of lithium is what is called a lithium-ion secondary battery. In the lithium-ion secondary battery, lithium is inserted and extracted in an ionic state.

Note that in the lithium-ion secondary battery, a charge capacity of the negative electrode is preferably greater than a discharge capacity of the positive electrode. In other words, an electrochemical capacity per unit area of the negative electrode is preferably greater than an electrochemical capacity per unit area of the positive electrode. This is to suppress precipitation of the electrode reactant on a surface of the negative electrode during charging.

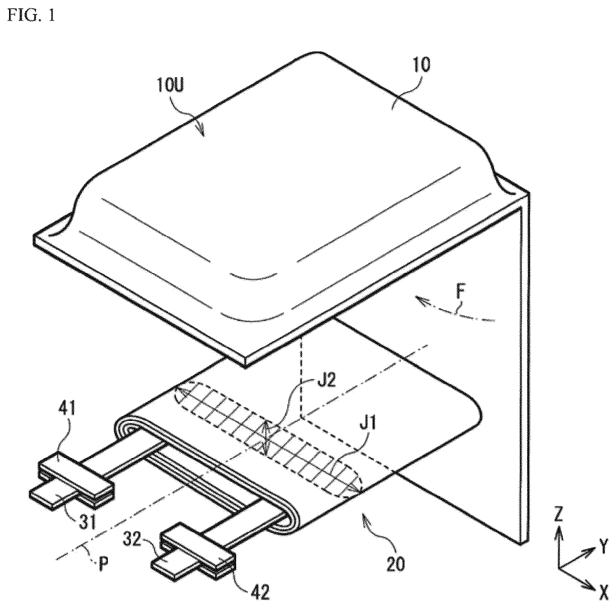

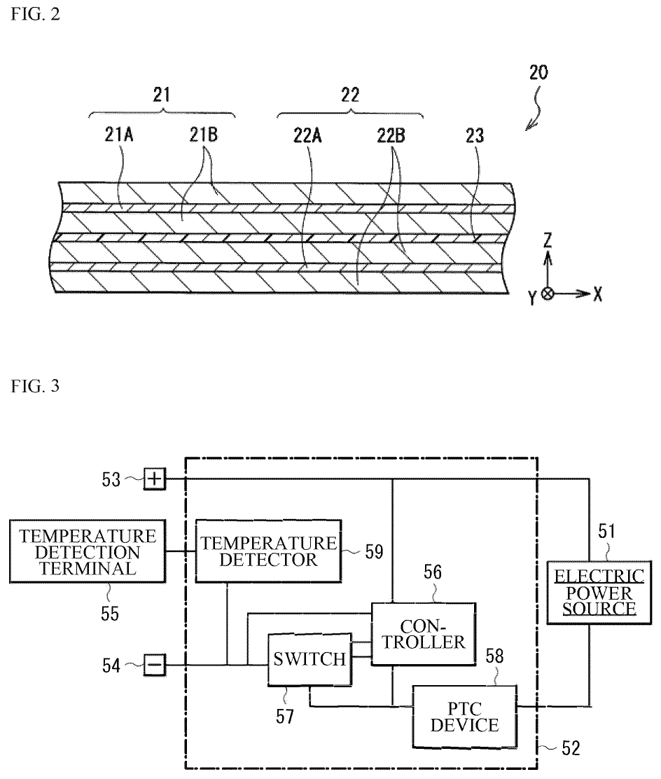

FIG. 1 illustrates a perspective configuration of the secondary battery. FIG. 2 illustrates, in an enlarged manner, a sectional configuration of a battery device 20 illustrated in FIG. 1.

Note that FIG. 1 illustrates a state in which an outer package film 10 and the battery device 20 are separated from each other, and indicates a section of the battery device 20 along an XZ plane by a dashed line. FIG. 2 illustrates only a part of the battery device 20.

As illustrated in FIGS. 1 and 2, the secondary battery includes the outer package film 10, the battery device 20, a positive electrode lead 31, a negative electrode lead 32, and sealing films 41 and 42.

The secondary battery described here includes the outer package film 10 having flexibility or softness as an outer package member to contain the battery device 20, as described above. Accordingly, the secondary battery illustrated in FIGS. 1 and 2 is a secondary battery of what is called a laminated-film type.

As illustrated in FIG. 1, the outer package film 10 has a pouch-shaped structure that is sealed in a state where the battery device 20 is contained in the outer package film 10. The outer package film 10 thus contains a positive electrode 21, a negative electrode 22, a separator 23, and an electrolytic solution (not illustrated).

Here, the outer package film 10 is a single film-shaped member and is folded toward a folding direction F. The outer package film 10 has a depression part 10U to place the battery device 20 therein. The depression part 10U is what is called a deep drawn part.

Specifically, the outer package film 10 is a three-layered laminated film including a fusion-bonding layer, a metal layer, and a surface protective layer stacked in this order from an inner side. In a state in which the outer package film 10 is folded, outer edge parts of the fusion-bonding layer opposed to each other are fusion-bonded to each other. The fusion-bonding layer includes a polymer compound such as polypropylene. The metal layer includes a metal material such as aluminum. The surface protective layer includes a polymer compound such as nylon.

Note that the outer package film 10 is not particularly limited in configuration or the number of layers, and may be single-layered or two-layered, or may include four or more layers.

The battery device 20 is contained in the outer package film 10. The battery device 20 is what is called a power generation device, and includes, as illustrated in FIGS. 1 and 2, the positive electrode 21, the negative electrode 22, the separator 23, and the electrolytic solution (not illustrated).

Here, the battery device 20 is what is called a wound electrode body. Therefore, the positive electrode 21 and the negative electrode 22 are wound about a winding axis P, being opposed to each other with the separator 23 interposed therebetween. As illustrated in FIG. 1, the winding axis P is a virtual axis extending in a Y-axis direction.

The battery device 20 is not particularly limited in three-dimensional shape. Here, the battery device 20 has an elongated three-dimensional shape. Accordingly, a section of the battery device 20 intersecting the winding axis P, that is, the section of the battery device 20 along the XZ plane, has an elongated shape defined by a major axis J1 and a minor axis J2.

The major axis J1 is a virtual axis that extends in an X-axis direction and has a length larger than a length of the minor axis J2. The minor axis J2 is a virtual axis that extends in a Z-axis direction intersecting the X-axis direction and has the length smaller than the length of the major axis J1. Here, the battery device 20 has an elongated cylindrical three-dimensional shape. Thus, the section of the battery device 20 has an elongated, substantially elliptical shape.

The positive electrode 21 includes, as illustrated in FIG. 2, a positive electrode current collector 21A and a positive electrode active material layer 21B. Note, however, that the positive electrode current collector 21A may be omitted.

The positive electrode current collector 21A has two opposed surfaces on each of which the positive electrode active material layer 21B is to be provided. The positive electrode current collector 21A includes an electrically conductive material such as a metal material. Specific examples of the electrically conductive material include aluminum.

The positive electrode active material layer 21B includes any one or more of positive electrode active materials which lithium is to be inserted into and extracted from. Note that the positive electrode active material layer 21B may further include any one or more of other materials. Examples of the other materials include a positive electrode binder and a positive electrode conductor. A method of forming the positive electrode active material layer 21B is not particularly limited, and is specifically a method such as a coating method.

Here, the positive electrode active material layer 21B is provided on each of the two opposed surfaces of the positive electrode current collector 21A. However, the positive electrode active material layer 21B may be provided only on one of the two opposed surfaces of the positive electrode current collector 21A on a side where the positive electrode 21 is opposed to the negative electrode 22.

The positive electrode active material is not particularly limited in kind, and specific examples thereof include a lithium-containing compound. The lithium-containing compound is a compound that includes lithium and one or more transition metal elements as constituent elements. The lithium-containing compound may further include one or more other elements as one or more constituent elements. The one or more other elements are not particularly limited in kind as long as the one or more other elements are each an element other than lithium and the transition metal elements. Specifically, the one or more other elements are any one or more of elements belonging to groups 2 to 15 in the long period periodic table. The lithium-containing compound is not particularly limited in kind, and is specifically, for example, an oxide, a phosphoric acid compound, a silicic acid compound, and a boric acid compound.

Specific examples of the oxide include LiNiO₂, LiCoO₂, LiCo_{0.98}Al_{0.01}Mg_{0.01}O₂, LiNi_{0.5}Co_{0.2}Mn_{0.3}O₂, LiNi_{0.8}Co_{0.15}Al_{0.05}O₂, LiNi_{0.33}Co_{0.33}Mn_{0.33}O₂, Li_{1.2}Mn_{0.52}Co_{0.175}Ni_{0.1}O₂, Li_{1.15}(Mn_{0.65}Ni_{0.22}Co_{0.13})O₂, and LiMn₂O₄. Specific examples of the phosphoric acid compound include LiFePO₄, LiMnPO₄, LiFe_{0.5}Mn_{0.5}PO₄, and LiFe_{0.3}Mn_{0.7}PO₄.

The positive electrode binder includes any one or more of materials including, without limitation, a synthetic rubber and a polymer compound. Specific examples of the synthetic rubber include a styrene-butadiene-based rubber, a fluorine-based rubber, and ethylene propylene diene. Specific examples of the polymer compound include polyvinylidene difluoride, polyimide, and carboxymethyl cellulose.

The positive electrode conductor includes any one or more of electrically conductive materials including, without limitation, a carbon material, a metal material, and an electrically conductive polymer compound. Specific examples of the carbon material include graphite, carbon black, acetylene black, and Ketjen black.

The negative electrode 22 includes, as illustrated in FIG. 2, a negative electrode current collector 22A and a negative electrode active material layer 22B. Note, however, that the negative electrode current collector 22A may be omitted.

The negative electrode current collector 22A has two opposed surfaces on each of which the negative electrode active material layer 22B is to be provided. The negative electrode current collector 22A includes an electrically conductive material such as a metal material. Specific examples of the electrically conductive material include copper.

The negative electrode active material layer 22B includes any one or more of negative electrode active materials which lithium is to be inserted into and extracted from. Note that the negative electrode active material layer 22B may further include any one or more of other materials. Examples of the other materials include a negative electrode binder and a negative electrode conductor. A method of forming the negative electrode active material layer 22B is not particularly limited, and specifically includes any one or more of methods including, without limitation, a coating method, a vapor-phase method, a liquid-phase method, a thermal spraying method, and a firing (sintering) method.

Here, the negative electrode active material layer 22B is provided on each of the two opposed surfaces of the negative electrode current collector 22A. However, the negative electrode active material layer 22B may be provided only on one of the two opposed surfaces of the negative electrode current collector 22A on a side where the negative electrode 22 is opposed to the positive electrode 21.

The negative electrode active material is not particularly limited in kind, and specific examples thereof include a carbon material and a metal-based material. One reason for this is that a high energy density is obtainable.

Specific examples of the carbon material include graphitizable carbon, non-graphitizable carbon, and graphite. The graphite may include natural graphite, artificial graphite, or both.

The term “metal-based material” is a generic term for materials each including, as one or more constituent elements, any one or more elements among metal elements and metalloid elements that are each able to form an alloy with lithium. Specific examples of such metal elements and metalloid elements include silicon and tin. The metal-based material may be a simple substance, an alloy, a compound, a mixture of two or more thereof, or a material including two or more phases thereof. Note that the simple substance may include any amount of impurity. Specific examples of the metal-based material include TiSi₂ and SiOₓ (0<x≤2 or 0.2<x<1.4).

Details of the negative electrode binder are similar to those of the positive electrode binder. Details of the negative electrode conductor are similar to those of the positive electrode conductor.

The separator 23 is an insulating porous film interposed between the positive electrode 21 and the negative electrode 22 as illustrated in FIG. 2, and allows lithium to pass therethrough in an ionic state while preventing occurrence of a short circuit to be caused by contact between the positive electrode 21 and the negative electrode 22. The separator 23 includes any one or more of insulating polymer compounds. Specific examples of the insulating polymer compounds include polyethylene.

The positive electrode 21, the negative electrode 22, and the separator 23 are each impregnated with the electrolytic solution, and the electrolytic solution has the configuration described above. That is, the solvent includes the anisole compound, and the content of the anisole compound in the solvent falls within the above-described range.

As illustrated in FIGS. 1 and 2, the positive electrode lead 31 is a positive electrode wiring coupled to the positive electrode current collector 21A of the positive electrode 21, and is led to an outside of the outer package film 10. The positive electrode lead 31 includes any one or more of electrically conductive materials including, without limitation, a metal material. Specific examples of the electrically conductive material include aluminum. The positive electrode lead 31 has any one of shapes including, without limitation, a thin plate shape and a meshed shape.

As illustrated in FIGS. 1 and 2, the negative electrode lead 32 is a negative electrode wiring coupled to the negative electrode 22, and is led to the outside of the outer package film 10. Here, the negative electrode lead 32 is led toward a direction similar to that in which the positive electrode lead 31 is led out. The negative electrode lead 32 includes any one or more of electrically conductive materials including, without limitation, a metal material. Specific examples of the electrically conductive material include copper. Details of a shape of the negative electrode lead 32 are similar to those of the shape of the positive electrode lead 31.

The sealing film 41 is disposed between the outer package film 10 and the positive electrode lead 31, as illustrated in FIG. 1. The sealing film 42 is disposed between the outer package film 10 and the negative electrode lead 32, as illustrated in FIG. 1. Note that the sealing film 41, the sealing film 42, or both may be omitted.

The sealing film 41 is a sealing member that prevents entry of, for example, outside air into the outer package film 10. The sealing film 41 includes a polymer compound such as a polyolefin that has adherence to the positive electrode lead 31. Specific examples of the polymer compound include polypropylene.

The sealing film 42 has a configuration similar to that of the sealing film 41 except that the sealing film 42 is a sealing member that has adherence to the negative electrode lead 32. That is, the sealing film 42 includes a polymer compound such as a polyolefin that has adherence to the negative electrode lead 32.

The secondary battery operates as described below in the battery device 20.

Upon charging, lithium is extracted from the positive electrode 21, and the extracted lithium is inserted into the negative electrode 22 via the electrolytic solution. Upon discharging, lithium is extracted from the negative electrode 22, and the extracted lithium is inserted into the positive electrode 21 via the electrolytic solution. Upon each of the discharging and the charging, lithium is inserted and extracted in an ionic state.

To manufacture the secondary, each of the positive electrode 21 and the negative electrode 22 is fabricated, following which the secondary battery is assembled and the assembled secondary battery is subjected to a stabilization process, according to an example procedure to be described below.

Note that the manufacturing method of the electrolytic solution is not described below because it has already been described above.

First, the positive electrode active material, the positive electrode binder, and the positive electrode conductor are mixed with each other to thereby obtain a positive electrode mixture. Thereafter, the positive electrode mixture is put into a solvent to thereby prepare a positive electrode mixture slurry in paste form. The solvent may be an aqueous solvent, or may be an organic solvent.

Lastly, the positive electrode mixture slurry is applied on the two opposed surfaces of the positive electrode current collector 21A to thereby form the positive electrode active material layers 21B. Thereafter, the positive electrode active material layers 21B may be compression-molded by a compression device such as a roll pressing machine. In this case, the positive electrode active material layers 21B may be heated. The positive electrode active material layers 21B may be compression-molded multiple times. The positive electrode active material layers 21B are thus formed on the two respective opposed surfaces of the positive electrode current collector 21A. As a result, the positive electrode 21 is fabricated.

The negative electrode 22 is formed by a procedure similar to the fabrication procedure of the positive electrode 21 described above. Specifically, first, a mixture (a negative electrode mixture) in which the negative electrode active material, the negative electrode binder, and the negative electrode conductor are mixed with each other is put into a solvent to thereby prepare a negative electrode mixture slurry in paste form. Details of the solvent are as described above. Lastly, the negative electrode mixture slurry is applied on the two opposed surfaces of the negative electrode current collector 22A to thereby form the negative electrode active material layers 22B. Thereafter, the negative electrode active material layers 22B may be compression-molded. Details of compression molding are as described above. The negative electrode active material layers 22B are thus formed on the two respective opposed surfaces of the negative electrode current collector 22A. As a result, the negative electrode 22 is fabricated.

First, the positive electrode lead 31 is coupled to the positive electrode current collector 21A of the positive electrode 21 by a joining method such as a welding method, and the negative electrode lead 32 is coupled to the negative electrode current collector 22A of the negative electrode 22 by the joining method such as the welding method.

Thereafter, the positive electrode 21 and the negative electrode 22 are stacked on each other with the separator 23 interposed therebetween to thereby form a stacked body (not illustrated). Thereafter, the stacked body is wound to thereby fabricate a wound body (not illustrated), following which the wound body is pressed by a compression device such as a pressing machine to thereby shape the wound body into an elongated shape. The shaped wound body has a configuration similar to the configuration of the battery device 20 except that the positive electrode 21, the negative electrode 22, and the separator 23 are each not impregnated with the electrolytic solution.

Thereafter, the wound body is placed in the depression part 10U, following which the outer package film 10 (the fusion-bonding layer/the metal layer/the surface protective layer) is folded to thereby cause parts of the outer package film 10 to be opposed to each other. Thereafter, outer edge parts of two sides of the fusion-bonding layer opposed to each other are bonded to each other by a bonding method such as a thermal-fusion-bonding method to thereby allow the wound body to be contained in the outer package film 10 having a pouch shape.

Lastly, the electrolytic solution is injected into the outer package film 10 having the pouch shape, following which outer edge parts of the remaining one side of the fusion-bonding layer opposed to each other are bonded to each other by the bonding method such as the thermal-fusion-bonding method. In this case, the sealing film 41 is interposed between the outer package film 10 and the positive electrode lead 31, and the sealing film 42 is interposed between the outer package film 10 and the negative electrode lead 32.

The wound body is thereby impregnated with the electrolytic solution, and the battery device 20 is thus fabricated. Accordingly, the battery device 20 is sealed in the outer package film 10 having the pouch shape. The secondary battery is thus assembled.

The assembled secondary battery is charged and discharged. Stabilization conditions including, for example, an environment temperature, the number of times of charging and discharging (the number of cycles), and charging and discharging conditions may be set as desired.

A film is thereby formed on the surface of each of the positive electrode 21 and the negative electrode 22. In this case, a film derived from the anisole compound is formed on the surface of the negative electrode 22, as described above.

As a result, the battery device 20 is brought into an electrochemically stable state, and the secondary battery is thus completed.

According to the secondary battery, the electrolytic solution has the above-described configuration. Accordingly, for the above-described reasons, the decomposition reaction of the electrolytic solution is suppressed on the surface of the negative electrode 22 upon charging and discharging of the secondary battery while safety is secured during the use of the secondary battery. It is thus possible to achieve a superior battery characteristic and superior safety.

In particular, the secondary battery may include a lithium-ion secondary battery. This makes it possible to obtain a sufficient battery capacity stably through insertion and extraction of lithium. Accordingly, it is possible to achieve higher effects.

Other action and effects of the secondary battery are similar to those of the electrolytic solution described above.

The configuration of the secondary battery is appropriately modifiable as described below. Note that any of the following series of modification examples may be combined with each other.

Described above is the case where the negative electrode active material layer 22B of the negative electrode 22 includes the negative electrode active material which lithium is to be inserted into and extracted from and the secondary battery is therefore a lithium-ion secondary battery using insertion and extraction of lithium. However, although not specifically illustrated here, the secondary battery may be a lithium-metal secondary battery that uses precipitation and dissolution of lithium.

The secondary battery (the lithium-metal secondary battery) to be described here has a configuration similar to the configuration of the lithium-ion secondary battery except that the negative electrode 22 includes a simple substance of lithium, i.e., what is called a lithium metal. Specifically, the negative electrode 22 is, for example, a lithium metal foil. Note that the lithium metal may include any amount of impurity.

In the secondary battery, upon charging, lithium is extracted from the positive electrode 21 in an ionic state, and the lithium metal is precipitated on the surface of the negative electrode 22. Upon discharging, the lithium metal is dissolved from the negative electrode 22, and lithium is inserted into the positive electrode 21 in an ionic state.

A manufacturing method of this secondary battery is similar to the manufacturing method of the lithium-ion secondary battery except that the negative electrode 22 including the lithium metal is used.

In this secondary battery also, the battery capacity is obtainable through precipitation and dissolution of lithium. Accordingly, it is possible to achieve similar effects.

The separator 23 that is a porous film is used. However, although not specifically illustrated here, a separator of a stacked type including a polymer compound layer may be used.

Specifically, the separator of the stacked type includes a porous film having two opposed surfaces, and the polymer compound layer provided on one of or each of the two opposed surfaces of the porous film. One reason for this is that this improves adherence of the separator to each of the positive electrode 21 and the negative electrode 22, and thus suppresses misalignment of the battery device 20. This suppresses winding displacement of each of the positive electrode 21, the negative electrode 22, and the separator 23, and thus suppresses swelling of the secondary battery even if the decomposition reaction of the electrolytic solution occurs. The polymer compound layer includes, for example, polyvinylidene difluoride. One reason for this is that polyvinylidene difluoride is superior in physical strength and is electrochemically stable.

Note that the porous film, the polymer compound layer, or both may include any one or more kinds of insulating particles. One reason for this is that the insulating particles dissipate heat upon heat generation by the secondary battery, thus improving safety or heat resistance of the secondary battery. The insulating particles include any one or more of insulating materials including, without limitation, an inorganic material and a resin material. Specific examples of the inorganic material include aluminum oxide, aluminum nitride, boehmite, silicon oxide, titanium oxide, magnesium oxide, and zirconium oxide. Specific examples of the resin material include acrylic resin and styrene resin.

To fabricate the separator of the stacked type, a precursor solution including, without limitation, the polymer compound and an organic solvent is prepared, following which the precursor solution is applied on one of or each of the two opposed surfaces of the porous film. In this case, the precursor solution may include the insulating particles.

When the separator of the stacked type is used also, lithium is movable in an ionic state between the positive electrode 21 and the negative electrode 22, and similar effects are therefore achievable. In this case, in particular, the swelling of the secondary battery is further suppressed, as described above. Accordingly, it is possible to achieve higher effects.

The electrolytic solution, which is a liquid electrolyte, is used. However, although not specifically illustrated here, an electrolyte layer, which is a gel electrolyte, may be used.

In the battery device 20 including the electrolyte layer, the positive electrode 21 and the negative electrode 22 are wound, being opposed to each other with the separator 23 and the electrolyte layer interposed therebetween. The electrolyte layer is interposed between the positive electrode 21 and the separator 23, and between the negative electrode 22 and the separator 23.

Specifically, the electrolyte layer includes a polymer compound together with the electrolytic solution. The electrolytic solution is held by the polymer compound. One reason for this is that this prevents leakage of the electrolytic solution. The configuration of the electrolytic solution is as described above. The polymer compound includes, for example, polyvinylidene difluoride. To form the electrolyte layer, a precursor solution including, for example, the electrolytic solution, the polymer compound, and a solvent is prepared, following which the precursor solution is applied on one side or both sides of the positive electrode 21 and on one side or both sides of the negative electrode 22.

When the electrolyte layer is used also, lithium ions are movable between the positive electrode 21 and the negative electrode 22 via the electrolyte layer, and similar effects are therefore achievable. In this case, in particular, the leakage of the electrolytic solution is prevented, as described above. Accordingly, it is possible to achieve higher effects.

A description is given of applications (application examples) of the secondary battery according to an embodiment.

The applications of the secondary battery are not particularly limited. The secondary battery used as a power source may serve as a main power source or an auxiliary power source in, for example, electronic equipment and an electric vehicle. The main power source is preferentially used regardless of the presence of any other power source. The auxiliary power source may be used in place of the main power source, or may be switched from the main power source.

Specific examples of the applications of the secondary battery include: electronic equipment; apparatuses for data storage; electric power tools; battery packs to be mounted on, for example, electronic equipment; medical electronic equipment; electric vehicles; and electric power storage systems. Examples of the electronic equipment include video cameras, digital still cameras, mobile phones, laptop personal computers, headphone stereos, portable radios, and portable information terminals. Examples of the apparatuses for data storage include backup power sources and memory cards. Examples of the electric power tools include electric drills and electric saws. Examples of the medical electronic equipment include pacemakers and hearing aids. Examples of the electric vehicles include electric automobiles including hybrid automobiles. Examples of the electric power storage systems include battery systems for home use or industrial use in which electric power is accumulated for a situation such as emergency. In each of the above-described applications, one secondary battery may be used, or multiple secondary batteries may be used.

The battery pack may include a battery cell, or may include an assembled battery. The electric vehicle is a vehicle that travels with the secondary battery as a driving power source, and may be a hybrid automobile that is additionally provided with a driving source other than the secondary battery. In an electric power storage system for home use, electric power accumulated in the secondary battery serving as an electric power storage source may be utilized for using, for example, home appliances.

An application example of the secondary battery will now be described in detail. The configuration described below is merely an example, and is appropriately modifiable.

FIG. 3 illustrates a block configuration of a battery pack as the application example of the secondary battery. The battery pack described here is a battery pack (what is called a soft pack) including one secondary battery, and is to be mounted on, for example, electronic equipment typified by a smartphone.

As illustrated in FIG. 3, the battery pack includes an electric power source 51 and a circuit board 52. The circuit board 52 is coupled to the electric power source 51, and includes a positive electrode terminal 53, a negative electrode terminal 54, and a temperature detection terminal 55.

The electric power source 51 includes one secondary battery. The secondary battery has a positive electrode lead coupled to the positive electrode terminal 53 and a negative electrode lead coupled to the negative electrode terminal 54. The electric power source 51 is couplable to outside via the positive electrode terminal 53 and the negative electrode terminal 54, and is thus chargeable and dischargeable. The circuit board 52 includes a controller 56, a switch 57, a PTC device 58 as a thermosensitive resistive device, and a temperature detector 59. However, the PTC device 58 may be omitted.

The controller 56 includes, for example, a central processing unit (CPU) and a memory, and controls an overall operation of the battery pack. The controller 56 performs, for example, detection and control of a use state of the electric power source 51.

If a voltage of the electric power source 51 (the secondary battery) reaches an overcharge detection voltage or an overdischarge detection voltage, the controller 56 turns off the switch 57. This prevents a charging current from flowing into a current path of the electric power source 51. The overcharge detection voltage is not particularly limited and is specifically 4.20 V±0.05 V. The overdischarge detection voltage is not particularly limited and is specifically 2.40 V 0.10 V.

The switch 57 includes, for example, a charge control switch, a discharge control switch, a charging diode, and a discharging diode. The switch 57 performs switching between coupling and decoupling between the electric power source 51 and external equipment in accordance with an instruction from the controller 56. The switch 57 includes, for example, a metal-oxide-semiconductor field-effect transistor (MOSFET). Each of the charging current and the discharging current is detected based on an ON-resistance of the switch 57.

The temperature detector 59 includes a temperature detection device such as a thermistor. The temperature detector 59 measures a temperature of the electric power source 51 through the temperature detection terminal 55, and outputs a result of the temperature measurement to the controller 56. The result of the temperature measurement to be obtained by the temperature detector 59 is used, for example, when the controller 56 performs charge and discharge control upon abnormal heat generation or when the controller 56 performs a correction process upon calculating a remaining capacity.

### EXAMPLES

A description is given of Examples of the present technology according to an embodiment.

### Examples 1 to 4 and Comparative Examples 1 to 4

Secondary batteries were manufactured, following which the secondary batteries were each evaluated for a battery characteristic as described below.

### [Fabrication of Secondary Battery]

Here, test secondary batteries were each fabricated to conduct a simple evaluation for a battery characteristic in accordance with the following procedure. The test secondary batteries were each a simple lithium-metal secondary battery.

First, the electrolyte salt (lithium bis(fluorosulfonyl)imide) was put into the solvent, following which the solvent was stirred to prepare the electrolytic solution.

Used as the solvents were 4-(trifluoromethoxy)anisole (TFMAS) as the anisole compound and 1,2-dimethoxy ethane (DME) as the other compound. In this case, a mixture ratio between the anisole compound and the other compound was adjusted. The content of the electrolyte salt was set to 2 mol/l (=1 mol/dm³) with respect to the solvent.

The content (wt %) of the anisole compound in the solvent, the content (wt %) of the other compound in the solvent, and a boiling point (° C.) and a flash temperature (° C.) as physical properties of each of the anisole compound and the other compound were as listed in Table 1.

An electrolytic solution for comparison was prepared by a similar procedure, except that anisole (AS) as the other compound was used as the solvent, as indicated in Table 1.

Thereafter, a lithium metal foil (having a thickness of 0.1 mm) was compression-bonded to a copper foil (having a thickness of 0.01 mm) by using a pressing machine to fabricate a test electrode.

Thereafter, the electrolytic solution was dropped onto the separator (a fine porous polyethylene film having a thickness of 10 m) to thereby impregnate the separator with the electrolytic solution. An amount of the dropped electrolytic solution was 0.01 ml (=0.01 cm³).

Thereafter, a copper foil (having a thickness of 0.012 mm) was prepared as a counter electrode, following which the test electrode and the counter electrode were stacked on each other with the separator impregnated with the electrolytic solution interposed therebetween. The test electrode and the counter electrode were thus stacked on each other with the separator impregnated with the electrolytic solution interposed therebetween. As a result, the test secondary battery was completed.

### [Evaluation of Battery Characteristic]

The secondary batteries were each evaluated for the battery characteristic in accordance with the following procedure, and the evaluation revealed the results presented in Table 1.

Here, a charge and discharge characteristic was evaluated as the battery characteristic to examine reversibility of precipitation and dissolution of lithium on a surface of the counter electrode. In this case, safety was also examined based on the above-described physical properties (the boiling point and the flash temperature) of the solvent.

To evaluate the charge and discharge characteristic, first, the secondary battery was charged in an ambient temperature environment (at a temperature of 23° C.) to thereby measure a charge capacity, following which the secondary battery was discharged to thereby measure a discharge capacity.

Upon charging, the secondary battery was charged at a current density of 0.22 mA/cm² until a total charge time reached three hours. Upon discharging, the secondary battery was discharged until a voltage reached 0.1 V.

Thereafter, coulombic efficiency was calculated based on the following calculation expression: coulombic efficiency (%)=(discharge capacity/charge capacity)×100.

Thereafter, the secondary battery was repeatedly charged and discharged in the same environment and the coulombic efficiency was calculated for each cycle until the number of cycles reached 25. The charging and discharging conditions were as described above.

Lastly, an average value of 16 respective values of the coulombic efficiency calculated in the 10th cycle to the 25th cycle was calculated to thereby obtain average coulombic efficiency as an index for evaluating the charge and discharge characteristic. The value of the average coulombic efficiency was a value rounded to one decimal place.

One reason why nine values of the coulombic efficiency calculated in earlier cycles of charging and discharging (the first cycle to the ninth cycle) were not used to calculate the average coulombic efficiency was that the coulombic efficiency could vary in the earlier cycles of charging and discharging. Variations in the coulombic efficiency were suppressed by not using the values of the coulombic efficiency calculated in the earlier cycles of charging and discharging and using only the values of the coulombic efficiency calculated in the later cycles of charging and discharging (the 10th cycle to the 25th cycle) to calculate the average coulombic efficiency. This secured calculation accuracy and reproducibility of the average coulombic efficiency.

TABLE 1

| | Solvent | | | | | | | | |
|---|---|---|---|---|---|---|---|---|---|
| | Anisole compound | | | | Other compound | | | | Average |
| | | | Boiling | Flash | | | Boiling | Flash | coulombic |
| | | Content | point | temperature | | Content | point | temperature | efficiency |
| | Kind | (wt %) | (° C.) | (° C.) | Kind | (wt %) | (° C.) | (° C.) | (%) |
| Comparative | — | — | — | — | DME | 100 | 84 | −2 | 99.1 |
| example 1 | | | | | | | | | |
| Comparative | TFMAS | 20 | 164 | 58 | DME | 80 | 84 | −2 | 95.1 |
| example 2 | | | | | | | | | |
| Example 1 | TFMAS | 30 | 164 | 58 | DME | 70 | 84 | −2 | 95.5 |
| Example 2 | TFMAS | 40 | 164 | 58 | DME | 60 | 84 | −2 | 95.8 |
| Example 3 | TFMAS | 60 | 164 | 58 | DME | 40 | 84 | −2 | 98.7 |
| Example 4 | TFMAS | 80 | 164 | 58 | DME | 20 | 84 | −2 | 99.4 |
| Comparative | — | — | — | — | DME + AS | 60 + 40 | 84 + 154 | −2, 51 | 78.4 |
| example 3 | | | | | | | | | |
| Comparative | — | — | — | — | AS | 100 | 154 | 51 | — |
| example 4 | | | | | | | | | |

As indicated in Table 1, the physical properties (the boiling point and the flash temperature) of the solvent and the average coulombic efficiency varied depending on the kind and the composition of the solvent.

Specifically, when the solvent included two kinds of other compounds (1,2-dimethoxyethane and anisole) (Comparative example 3), each of the boiling point and the flash temperature decreased and the average coulombic efficiency also decreased. In this case, in particular, each of the boiling point and the flash temperature greatly decreased due to 1,2-dimethoxyethane, and each of the boiling point and the flash temperature decreased due to anisole.

If each of the boiling point and the flash temperature decreases, when the temperature of the secondary battery increases due to a cause such as abnormal heat generation, the secondary battery can cause thermal runaway due to excessive volatilization of the electrolytic solution and the secondary battery can burn due to ignition.

When the solvent included one kind of other compound (anisole) (Comparative example 4), it was not possible to charge and discharge the secondary battery in the first place. Therefore, it was not possible to calculate the average coulombic efficiency.

In contrast, when the solvent included the anisole compound (4-(trifluoromethoxy)anisole), the other compound (1,2-dimethoxyethane), or both (Examples 1 to 4 and Comparative examples 1 and 2), each of the boiling point and the flash temperature varied depending on the kind of the solvent, and the average coulombic efficiency also varied depending on the composition of the solvent.

When the solvent included only the other compound (1,2-dimethoxyethane) (Comparative example 1), the average coulombic efficiency increased, but each of the boiling point and the flash temperature greatly decreased.

Similarly, when the solvent included the anisole compound (4-(trifluoromethoxy)anisole) and the other compound (1,2-dimethoxyethane) but the content of the anisole compound in the solvent was less than 30 wt % (Comparative example 2), the average coulombic efficiency increased, but each of the boiling point and the flash temperature greatly decreased due to the other compound (1,2-dimethoxyethane) occupying a large part of the solvent.

When the solvent included the anisole compound (4-(trifluoromethoxy)anisole) and the other compound (1,2-dimethoxyethane), and the content of the anisole compound in the solvent was 30 wt % or greater (Examples 1 to 4), the average coulombic efficiency increased. In this case, it was possible to sufficiently increase a proportion of the anisole compound having a high boiling point and a high flash temperature by relatively and sufficiently decreasing a proportion of the other compound having a low boiling point and a low flash temperature, while securing the average coulombic efficiency.

If each of the boiling point and the flash temperature increases, when the temperature of the secondary battery increases due to abnormal heat generation, the possibility that the secondary battery causes runaway due to excessive volatilization of the electrolytic solution decreases and the possibility that the secondary battery burns due to ignition also decreases.

Further, if the average coulombic efficiency increases, charge and discharge efficiency of the secondary battery including the electrolytic solution increases. Therefore, a high battery capacity is obtainable.

When the solvent included the anisole compound, and the content of the anisole compound in the solvent was 30 wt % or greater, in particular, the following tendencies were obtained.

Firstly, when the content of the anisole compound in the solvent was 60 wt % or greater, the average coulombic efficiency further increased.

Secondly, when the content of the anisole compound in the solvent was 80 wt % or less, high average coulombic efficiency was obtained.

Thirdly, when the anisole compound included the compound represented by Formula (2), sufficient coulombic efficiency was obtained. In this case, when the anisole compound included 4-(trifluoromethoxy)anisole, sufficient coulombic efficiency was obtained as described above.

Based on the results indicated in Table 1, when the solvent included the anisole compound and the content of the anisole compound in the solvent was 30 wt % or greater, high average coulombic efficiency was obtained while the physical properties (the boiling point and the flash temperature) of the solvent were secured. The charge and discharge characteristic was thus improved while safety was secured. Accordingly, the secondary battery obtained a superior battery characteristic and superior safety.

Although the present technology has been described above with reference to one or more embodiments including Examples, the present technology is not limited thereto, and is therefore modifiable in a variety of ways.

For example, the description has been given of the case where the secondary battery has a battery structure of the laminated-film type. However, the battery structure of the secondary battery is not particularly limited, and may be, for example, of a cylindrical type, a prismatic type, a coin type, or a button type.

Further, the description has been given of the case where the battery device has a device structure of a wound type. However, the device structure of the battery device is not particularly limited, and may be, for example, of a stacked type or a zigzag folded type. In the stacked type, the positive electrode and the negative electrode are alternately stacked on each other with the separator interposed therebetween. In the zigzag folded type, the positive electrode and the negative electrode are opposed to each other with the separator interposed therebetween, and are folded in a zigzag manner.

Further, although the description has been given of the case where the electrode reactant is lithium, the electrode reactant is not particularly limited. Specifically, the electrode reactant may be another alkali metal such as sodium or potassium, or may be an alkaline earth metal such as beryllium, magnesium, or calcium, as described above. In addition, the electrode reactant may be another light metal such as aluminum.

The effects described herein are mere examples, and effects of the present technology are therefore not limited to those described herein. Accordingly, the present technology may achieve any other effect.

Note that the present technology may have any of the following configurations according to an embodiment.

<1>

A secondary battery including:
a positive electrode;
a negative electrode; and
an electrolytic solution including a solvent, in which
the solvent includes an anisole compound represented by Formula (1), and
a content of the anisole compound in the solvent is 30 weight percent or greater,

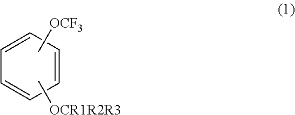

where each of R1, R2, and R3 is either a hydrogen group or a halogen group.
   <2>

The secondary battery according to <1>, in which the content of the anisole compound in the solvent is 60 weight percent or greater.

<3>

The secondary battery according to <1> or <2>, in which the content of the anisole compound in the solvent is 80 weight percent or less.

<4>

The secondary battery according to any one of <1> to <3>, in which the halogen group includes a fluorine group.

<5>

The secondary battery according to any one of <1> to <4>, in which the anisole compound includes a compound represented by Formula (2),

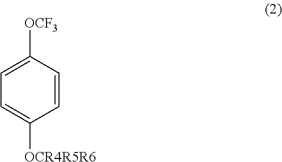

where each of R4, R5, and R6 is either a hydrogen group or a halogen group.
   <6>

The secondary battery according to any one of <1> to <5>, in which the anisole compound includes 4-(trifluoromethoxy)anisole.

<7>

The secondary battery according to any one of <1> to <6>, in which the secondary battery includes a lithium-ion secondary battery.

<8>

An electrolytic solution for a secondary battery, the electrolytic solution including
a solvent, in which
the solvent includes an anisole compound represented by Formula (1), and
a content of the anisole compound in the solvent is 30 weight percent or greater,

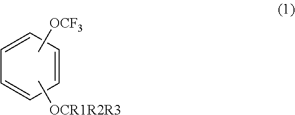

where each of R1, R2, and R3 is either a hydrogen group or a halogen group.

### REFERENCE SIGNS LIST

21 . . . positive electrode
22 . . . negative electrode

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A secondary battery comprising:
a positive electrode;
a negative electrode; and
an electrolytic solution including a solvent, wherein
the solvent includes an anisole compound represented by Formula (1), and
a content of the anisole compound in the solvent is 30 weight percent or greater, 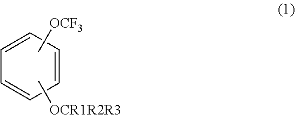
where each of R1, R2, and R3 is a hydrogen group or a halogen group.

2. The secondary battery according to claim 1, wherein the content of the anisole compound in the solvent is 60 weight percent or greater.

3. The secondary battery according to claim 1, wherein the content of the anisole compound in the solvent is 80 weight percent or less.

4. The secondary battery according to claim 1, wherein the halogen group includes a fluorine group.

5. The secondary battery according to claim 1, wherein the anisole compound includes a compound represented by Formula (2), 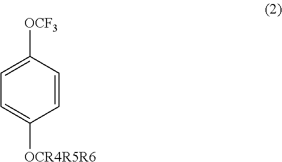
where each of R4, R5, and R6 is a hydrogen group or a halogen group.

6. The secondary battery according to claim 1, wherein the anisole compound includes 4-(trifluoromethoxy)anisole.

7. The secondary battery according to claim 1, wherein the secondary battery comprises a lithium-ion secondary battery.

8. An electrolytic solution for a secondary battery, the electrolytic solution comprising
a solvent, wherein
the solvent includes an anisole compound represented by Formula (1), and
a content of the anisole compound in the solvent is 30 weight percent or greater, 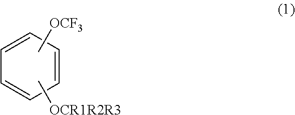
where each of R1, R2, and R3 is a hydrogen group or a halogen group.
